(19) United States
(12) Patent Application Publication
(10) Pub. No.: US 2022/0007852 A1
(43) Pub. Date: Jan. 13, 2022

(54) CHILD SAFETY SEAT WITH A DETACHABLE SEAT COVER

(71) Applicant: China Wonderland Nurserygoods Co., Ltd., Dongguan (CN)

(72) Inventors: Kyle S. Mason, Lititz, PA (US); Colin F. Eggert-Crowe, Philadelphia, PA (US)

(73) Assignee: China Wonderland Nurserygoods Co., Ltd., Dongguan (CN)

(21) Appl. No.: 17/368,805

(22) Filed: Jul. 6, 2021

(30) Foreign Application Priority Data
Jul. 10, 2020 (CN) 202021361204.5

(51) Int. Cl. A47D 15/00; B60N 2/28

(52) U.S. Cl. CPC A47D 15/00; B60N 2/28

(57) ABSTRACT

A child safety seat includes a seat body, a fastening buckle and a seat cover. The fastening buckle includes a fastening portion and a restraining portion. An end of the fastening portion is fixedly connected to the seat body, and another end of the fastening portion is fixedly connected to the restraining portion to form a connection. A cross-section area of the fastening portion at the connection is less than a cross-section area of the restraining portion at the connection. The seat cover is detachably sleeved on the fastening portion. The restraining portion restrains the seat cover on the fastening portion to position the seat cover on the seat body. The child safety seat has simple structure for positioning the seat cover, and the seat cover can be installed on the seat body more conveniently, thereby having an advantage of simple production.

### BACKGROUND OF THE INVENTION

### 1. Field of the Invention

The present invention relates to a child safety seat, and more particularly, to a child safety seat with a detachable seat cover.

### 2. Description of the Prior Art

A child safety seat is a seat specially designed for children. By assembling the child safety seat in a car, the child can ride on the child safety seat, so that the child can be restrained by the child safety seat to ensure safety of the child. Taking a basket-type child safety seat as an example, the conventional basket-type child safety seat generally includes a base and a seat body installed on the base, and a seat cover is installed outside the seat body to provide shield for the child. However, in the existing basket-type child safety seat, the seat cover is usually fixedly connected to the seat body, which has disadvantages of complicated manufacture and high production cost. In addition, the dirty seat cover cannot be disassembled and is difficult to be cleaned or replaced, which affects the cleanliness of the child safety seat.

### SUMMARY OF THE INVENTION

Therefore, an objective of the present invention is to provide a child safety seat with a detachable seat cover, for solving the aforementioned problems.

In order to achieve the aforementioned objective, the present invention discloses a child safety seat including a seat body, at least one fastening buckle and a seat cover. The at least one fastening buckle includes a fastening portion and a restraining portion. An end of the fastening portion is fixedly connected to the seat body, and another end of the fastening portion is fixedly connected to the restraining portion to form a connection. A cross-section area of the fastening portion at the connection is less than a cross-section area of the restraining portion at the connection. The seat cover is detachably sleeved on the fastening portion. The restraining portion restrains the seat cover on the fastening portion to position the seat cover on the seat body.

Preferably, the seat cover includes at least one engaging opening, and the seat cover is sleeved on the fastening portion through the at least one engaging opening.

Preferably, the child safety seat includes a plurality of fastening buckles spaced on a rear side of the seat body, and the seat cover is sleeved on fastening portions of the plurality of fastening buckles.

Preferably, the seat cover is a canopy cloth.

Preferably, the child safety seat further includes a head cushion and a back cushion respectively disposed on the seat body and connected to each other.

Preferably, the head cushion includes at least one first snap fastener, and the back cushion includes at least one second snap fastener for engaging with the at least one first snap fastener.

Preferably, the head cushion includes at least one first sewing structure disposed on an outer periphery of the at least one first snap fastener.

Preferably, the back cushion includes at least one second sewing structure disposed on an outer periphery of the at least one second snap fastener.

Preferably, one of the at least one first snap fastener and the at least one second snap fastener is a male snap fastener, and the other of the at least one first snap fastener and the at least one second snap fastener is a female snap fastener.

Preferably, the child safety seat further includes a base for connecting with a car seat, and the seat body is installed on the base.

In summary, the child safety seat provides the fastening buckle on the seat body, the seat cover can be detachably sleeved on the fastening portion of the fastening buckle, and the restraining portion restrains the seat cover on the fastening portion so as to position the seat cover on the seat body. Therefore, the child safety seat has simple structure for positioning the seat cover, and the seat cover can be installed on the seat body more conveniently, thereby having an advantage of simple production. In addition, the seat cover can also be removed from the seat body, which is convenient for the user to clean or replace the seat cover, thereby enhancing the cleanliness of the child safety seat.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a child safety seat of the present application.

FIG. 2 is a structural diagram of the child safety seat without illustrating a seat cover of the present application.

FIG. 3 is a structural diagram of the seat cover of the present application.

FIG. 4 is a structural diagram of a fastening buckle of the child safety seat of the present application.

FIG. 5 is a sectional diagram of a fastening portion and a restraining portion at a connection of the fastening buckle of the present application.

FIG. 6 is a structural diagram of a head cushion and a back cushion of the child safety seat of the present application.

FIG. 7 is a structural diagram of a first snap fastener and a second snap fastener separated from each other of the present application.

### DETAILED DESCRIPTION

In order to illustrate technical specifications and structural features as well as achieved purposes and effects of the present invention, relevant embodiments and figures are described as follows.

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure (s) being described. The components of the present invention can be positioned in a number of different orientations. As such, the directional terminology is used for purposes of illustration and is in no way limiting. Accordingly, the drawings and descriptions will be regarded as illustrative in nature and not as restrictive.

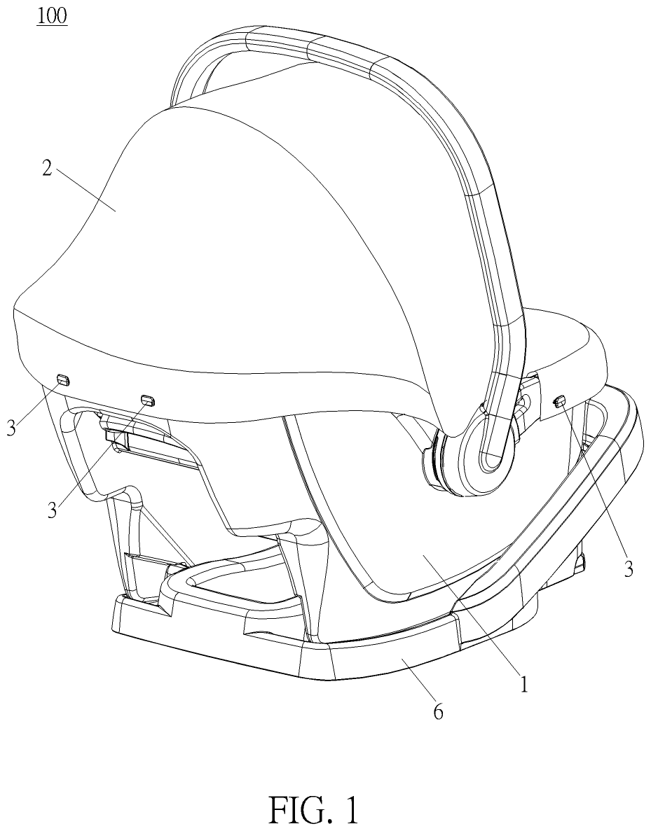

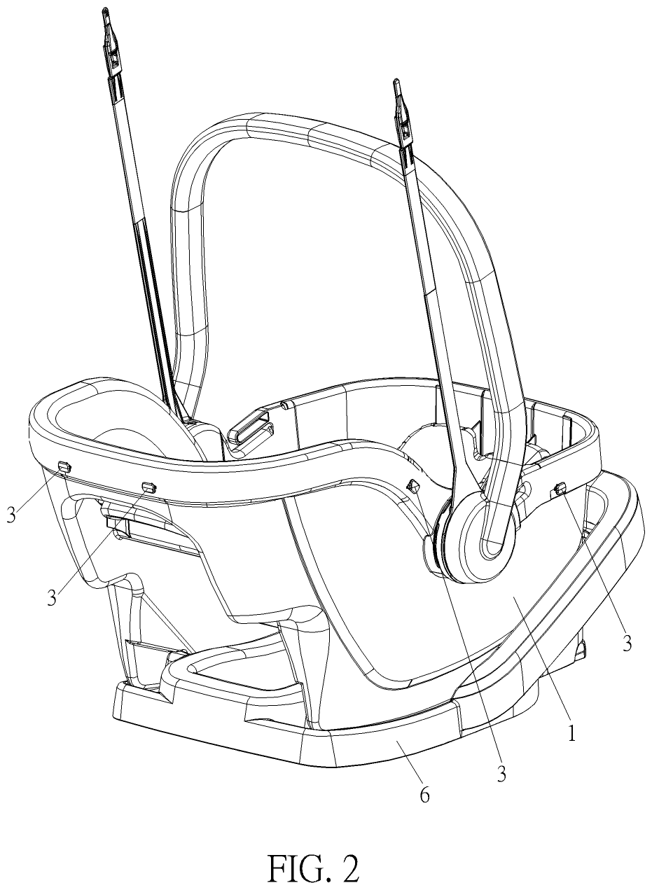

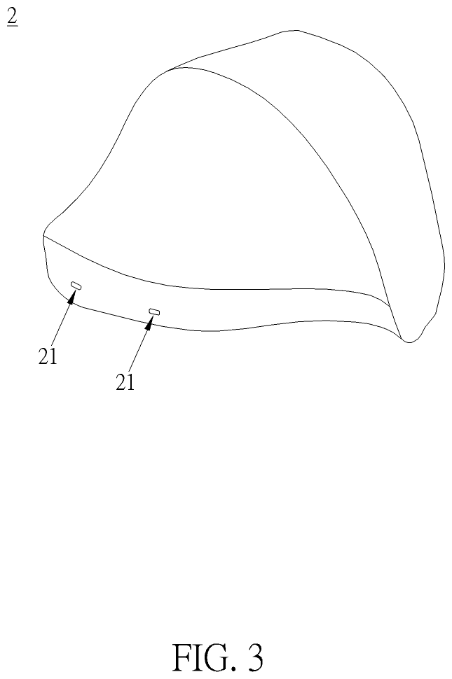

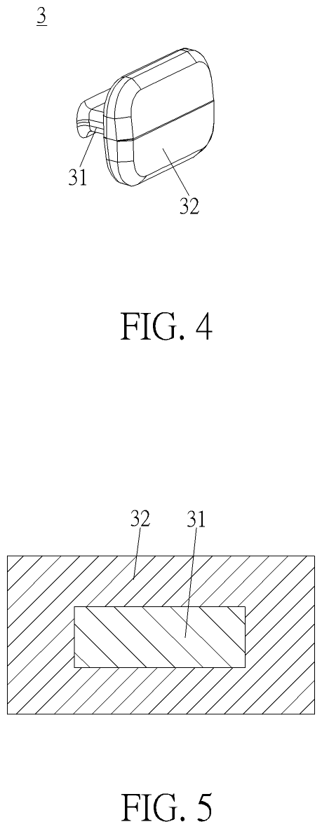

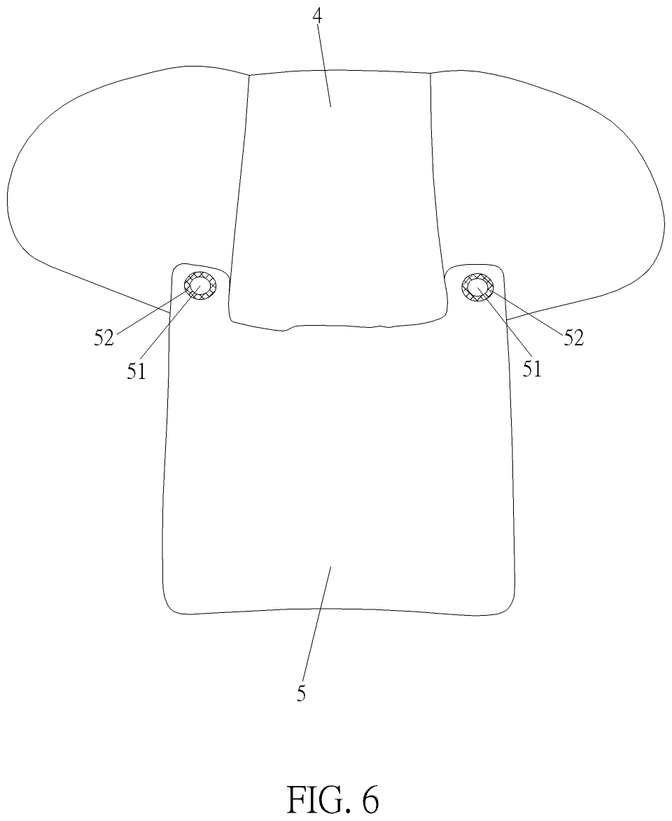

Please refer to FIG. 1 to FIG. 5. FIG. 1 is a schematic drawing of a child safety seat 100 of the present application. FIG. 2 is a structural diagram of the child safety seat 100 without illustrating a seat cover 2 of the present application. FIG. 3 is a structural diagram of the seat cover 2 of the present application. FIG. 4 is a structural diagram of a fastening buckle 3 of the child safety seat 100 of the present application. FIG. 5 is a sectional diagram of a fastening portion 31 and a restraining portion 32 at a connection of the fastening buckle 3 of the present application. The child safety seat 100 of the present application includes a seat body 1 and the seat cover 2. The seat body 1 includes at least one fastening buckle 3, and each fastening buckle 3 includes the fastening portion 31 and the restraining portion 32. An end of the fastening portion 31 is fixedly connected to the seat body 1, and another end of the fastening portion 31 is fixedly connected to the restraining portion 32 to form the connection. A cross-section area of the fastening portion 31 at the connection is less than a cross-section area of the restraining portion 32 at the connection. The seat cover 2 is detachably sleeved on the fastening portion 31, and the restraining portion 32 restrains the seat cover 2 on the fastening portion 31 to position the seat cover 2 on the seat body 1. Specifically, the seat cover 2 includes at least one engaging opening 21, and the seat cover 2 is sleeved on the fastening portion 31 through the at least one engaging opening 21. The seat cover 2 can pass through the engaging opening 21 to pass through the restraining portion 32 of the fastening buckle 3 and then to be sleeved on the fastening portion 31, so that the restraining portion 32 can restrain the seat cover 2 so as to prevent the seat cover 2 from falling off. In addition, the seat cover 2 can also be detached from the fastening buckle 3 through the at least one engaging opening 21 to facilitate cleaning or replacement of the seat cover 2.

Please refer to FIG. 1 and FIG. 3. In this embodiment, the seat cover 2 can be a canopy cloth. The child safety seat 100 can include a plurality of fastening buckles 3. For example, the child safety seat 100 can include a plurality of fastening buckles 3 spaced at intervals on a rear side of the seat body 1. In this embodiment, there are two fastening buckles 3 spaced on the rear side of the seat body 1, the seat cover 2 is sleeved on the two fastening portions 31 of the two fastening buckles 3, but it is not limited thereto. The seat cover 2 can also be a protective cloth disposed on an inner or outer side of the seat body 1, and the fastening buckle 3 can also be disposed at other positions, such as a front side, left and right sides of the seat body 1, to position the seat cover 2.

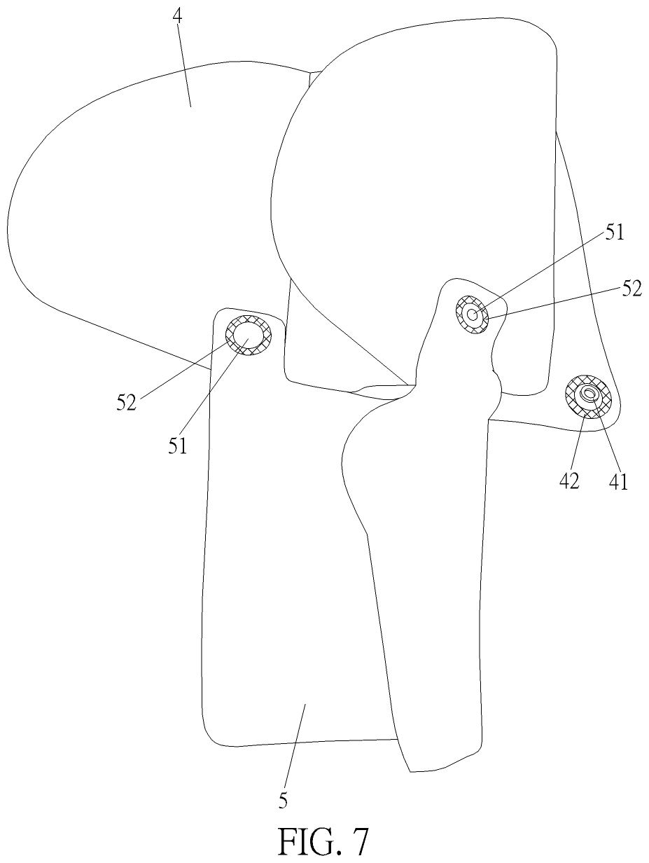

Please refer to FIG. 0.6 and FIG. 7. The child safety seat 100 further includes a head cushion 4 and a back cushion 5 respectively disposed on the seat body 1 and connected to each other. Specifically, the head cushion 4 includes at least one first snap fastener 41, and the back cushion 5 includes at least one second snap fastener 51 for engaging with the at least one first snap fastener 41. The head cushion 4 and the back cushion 5 can be connected with each other by engagement of the first snap fastener 41 and the second snap fastener 51. The head cushion 4 and the back cushion 5 can be detached from each other by pulling of the first snap fastener 41 and the second snap fastener 51 to separate the first snap fastener 41 and the second snap fastener 51. One of the first snap fastener 41 and the second snap fastener 51 is a male snap fastener, and the other of the first snap fastener 41 and the second snap fastener 51 is a female snap fastener. In this embodiment, the first snap fastener 41 is a male snap fastener, the second snap fastener 51 is a female snap fastener, but it is not limited thereto. Furthermore, the head cushion 4 includes at least one first sewing structure 42 disposed on an outer periphery of the at least one first snap fastener 41. The back cushion 5 includes at least one second sewing structure 52 disposed on an outer periphery of the at least one second snap fastener 51. By sewing a circle on the outer periphery of the first snap fastener 41 to form the first sewing structure 42 and sewing a circle on the outer periphery of the second snap fastener 51 to form the second sewing structure 52, it can enhance structural strength and effectively avoid damage to the first snap fastener 41 and the second snap fastener 51 due to pulling back and forth.

Please refer to FIG. 1. The child safety seat 100 further includes a base 6 for connecting with a car seat, and the seat body 1 is installed on the base 6. By assembling the base 6 with the car seat, the child can be restrained by the child safety seat 100 to ensure safety of the child.

In conclusion, the child safety seat 100 of the present application provides the fastening buckle 3 on the seat body 1, the seat cover 2 can be detachably sleeved on the fastening portion 31 of the fastening buckle 3, and the restraining portion 32 restrains the seat cover 2 on the fastening portion 31 so as to position the seat cover 2 on the seat body 1. Therefore, the child safety seat 100 of the present application has simple structure for positioning the seat cover 2, and the seat cover 2 can be installed on the seat body 1 more conveniently, thereby having an advantage of simple production. In addition, the seat cover 2 can also be removed from the seat body 1, which is convenient for the user to clean or replace the seat cover 2, thereby enhancing the cleanliness of the child safety seat 100.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A child safety seat comprising:
a seat body;
at least one fastening buckle comprising a fastening portion and a restraining portion, an end of the fastening portion being fixedly connected to the seat body, another end of the fastening portion being fixedly connected to the restraining portion to form a connection, and a cross-section area of the fastening portion at the connection being less than a cross-section area of the restraining portion at the connection; and
a seat cover detachably sleeved on the fastening portion, the restraining portion restraining the seat cover on the fastening portion to position the seat cover on the seat body.

2. The child safety seat of claim 1, wherein the seat cover comprises at least one engaging opening, and the seat cover is sleeved on the fastening portion through the at least one engaging opening.

3. The child safety seat of claim 1, wherein the child safety seat comprises a plurality of fastening buckles spaced on a rear side of the seat body, and the seat cover is sleeved on fastening portions of the plurality of fastening buckles.

4. The child safety seat of claim 1, wherein the seat cover is a canopy cloth.

5. The child safety seat of claim 1, further comprising a head cushion and a back cushion respectively disposed on the seat body and connected to each other.

6. The child safety seat of claim 5, wherein the head cushion comprises at least one first snap fastener, and the back cushion comprises at least one second snap fastener for engaging with the at least one first snap fastener.

7. The child safety seat of claim 6, wherein the head cushion comprises at least one first sewing structure disposed on an outer periphery of the at least one first snap fastener.

8. The child safety seat of claim 6, wherein the back cushion comprises at least one second sewing structure disposed on an outer periphery of the at least one second snap fastener.

9. The child safety seat of claim 6, wherein one of the at least one first snap fastener and the at least one second snap fastener is a male snap fastener, and the other of the at least one first snap fastener and the at least one second snap fastener is a female snap fastener.

10. The child safety seat of claim 1, further comprising a base for connecting with a car seat, and the seat body is installed on the base.
